(19) United States
(12) Patent Application Publication
(10) Pub. No.: US 2013/0024268 A1
(43) Pub. Date: Jan. 24, 2013

(54) INCENTIVIZING THE LINKING OF INTERNET CONTENT TO PRODUCTS FOR SALE

(71) Applicant: Kumaresan Manickavelu, Chennai (IN)

(72) Inventor: Kumaresan Manickavelu, Chennai (IN)

(73) Assignee: eBay Inc., San Jose, CA (US)

(21) Appl. No.: 13/188,746

(22) Filed: Jul. 22, 2011

(51) Int. Cl. G06Q 30/00; G06F 17/00

(52) U.S. Cl. 705/14.39; 715/205

(57) ABSTRACT

A method of establishing an association between a content item and an additional content item is disclosed, the content item published by a source that is external to a network-based publication system and the additional content item published by a source that is internal to the network-based publication system. A specification of an association between a portion of the content item and an additional content item is received. A product web tag is generated based on the specification of the association between the portion of the content item and the additional content item. A request is sent to share the product web tag on a server.

### TECHNICAL FIELD

The present application relates generally to the technical field of establishing associations between content items accessible on a network, and, in one specific example, to establishing associations between content items posted on the Internet and content items corresponding to products listed for sale on a network-based publication system.

### BACKGROUND

The amount of traffic a network-based publication system (e.g., eBay, Amazon, or Craig's List) receives may depend to some extent on associations between content items published by a source that is external from the network-based publication system and content items published by a source that is internal to the network-based publication system. For example, a network-based publication system may receive more traffic if content items published by sources that are external to the network-based publication system (e.g., news articles, blogs, and so on) were associated with content published by the network-based publication system on behalf of its users, such as content items corresponding to products listed for sale on the network-based publication system. Given the exponential growth of the Internet and sources of information external to network-based publication systems, it may be difficult for a network-based publication system to identify some associations between relevant content items and thus drive additional traffic to the network-based publication system.

### BRIEF DESCRIPTION OF THE DRAWINGS

Some embodiments are illustrated by way of example and not limitation in the figures of the accompanying drawings in which:

FIG. 1 is a network diagram depicting a client-server system within which various example embodiments may be deployed;

FIG. 2 is a block diagram illustrating multiple applications, including content-tagging applications, that, in various example embodiments, are provided as part of the networked system of FIG. 1;

FIG. 3 is a block diagram illustrating example modules of a software application module of the web client of FIG. 1;

FIG. 4 is a block diagram illustrating example modules of the content-tagging applications of FIG. 2;

FIG. 5 is a flowchart illustrating an example method of incentivizing users of a network-based publication system to install a client application or use the client application to manage product web tags;

FIG. 6 is a flowchart illustrating an example method of enabling users of a network-based publication system to share product web tags with one another;

FIG. 7 is a flowchart illustrating an example method of sending a notification of an association between a content item that a user is currently accessing and an additional content item;

FIG. 8 is a screenshot of an example user interface for accessing a user interface for managing web tags;

FIG. 9 is a screenshot of an additional example user interface for managing product web tags;

FIG. 10 is a screenshot of an example user interface for managing product web tags;

FIG. 11 is a screenshot of an example user interface for notifying a user of the existence of a product web tag for a content item that the user is currently accessing;

FIG. 12 is a screenshot of an example user interface for highlighting a portion of a content item for which a product web tag has been created;

FIG. 13 is a screenshot of an example user interface for viewing information about product web tags that have been created for a content item;

FIG. 14 is a screenshot of an example user interface of a web to which a user is directed upon clicking on a content item or a portion of a content item for which a product web tag has been created; and

FIG. 15 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

As defined herein, a web tag is a data item that includes a specification of an association between a first content item and a second content item, the first content item being accessible (e.g., using an Internet browser) at a first location (e.g., at a first URL) and the second content item being accessible at a second location (e.g., at a second URL). Unlike a link (or hyperlink or Web link) code (e.g., a HyperText Markup Language “link” code, such as an “a href” code), which is embedded in the code of a content item, a web tag may exist independently of the content item. Furthermore, a web tag may be created independently of the source of the first content item or a source of the second content item.

For example, a first user browsing a web page on the Internet may create a web tag that establishes an association between a first content item (or a portion of the first content item), such as an image, on the web page with a second content item (or a portion of a second content item) on an additional web page. The first user may then share the web tag he created with a second user (e.g., by sharing the web tag on a server that is accessible to the second user). Then, when the second user accesses the first content item, the second user may be notified of the web tag created by the first user (e.g., via a software application module embedded in a browser application that the first user and the second user have each installed, as described in more detail below). Furthermore, the user may be presented with an option to navigate directly from the first content item to the second content item independently of any link code embedded in the first content item. Thus, with web tags, associations between content items may be identified, managed, accessed, or used by users independently of the source of the first content item or the source of the second content item.

As defined herein, a product web tag is a data item that includes a specification of an association between a first content item and a second content item, the first content item being accessible at a first location and the second content item being accessible at a second location, the second content item further corresponding to a product (e.g., a product listed on a network-based publication system). As such, product web tags may be a subset of web tags or a product web tag may be a type of a web tag. For example, a user may browse a popular blog posting in which a blogger describes or comments on features of a Kindle cover that is listed (e.g., as being for sale) on a network-based publication system. The user may create a product web tag to define an association between a portion of the blog posting (e.g., the name of the Kindle cover) with a product web page on the network-based publication system corresponding to the product. Then, when a second user accesses the blog posting, the second user may be notified of the product web tag created by the first user. The second user may also be given the option to navigate directly to the product page corresponding to the listing of the product.

Consistent with various embodiments, a method of presenting a notification of an association between a content item and an additional content item is disclosed, the content item published by a source that is external to a network-based publication system and the additional content item published by a source that is internal to the network-based publication system. An accessing of a content item published by a source that is external to a network-based publication system is detected. A web tag corresponding to the content item is discovered. A notification of an association between the content item and the additional content item is presented.

Consistent with various embodiments, a method of managing an association between a content item and an additional content item is disclosed, the content item published by a source that is external to a network-based publication system and the additional content item published by a source that is internal to the network-based publication system. A request is received from a client to store a product web tag on a server or remove a product web tag from the server. The product web tag is stored on the server or the product web tag is removed from the server.

These methods and the various embodiments disclosed herein may be implemented as a computer system having one or more modules (e.g., hardware modules or software modules). These methods and the various embodiments disclosed herein may be embodied as instructions stored on a machine-readable medium that, when executed by a processor, cause the processor to perform the method.

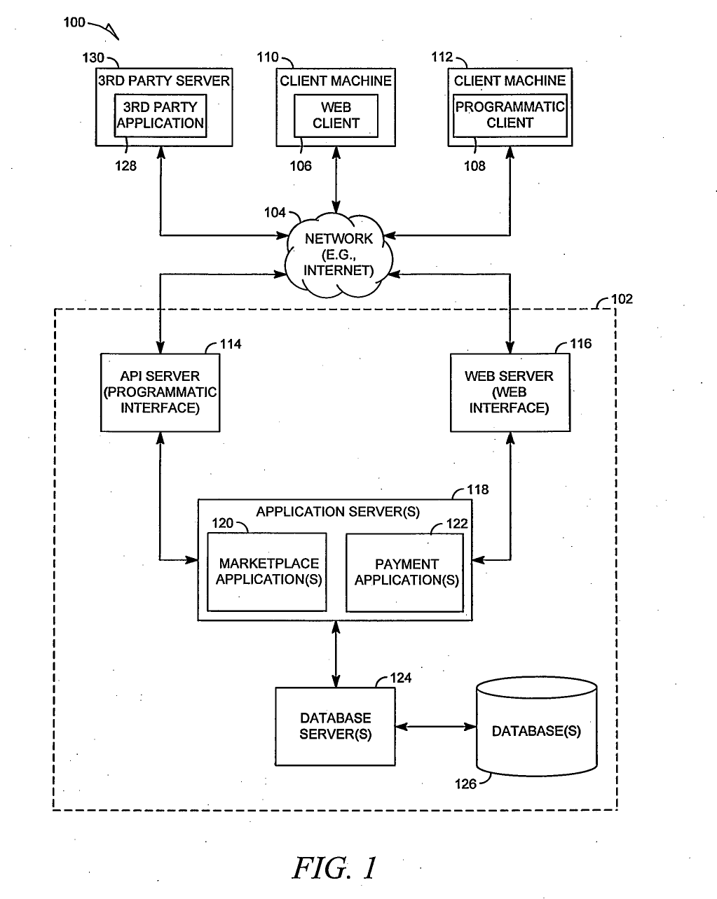

FIG. 1 is a network diagram depicting a client-server system 100, within which various example embodiments may be deployed. A networked system 102, in the example forms of a network-based marketplace or other publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112.

Each of the one or more clients may include a software application module (e.g., a plug-in, add-in, or macro) that adds a specific service or feature to a larger system. The software application module may be separate from but tightly-integrated into a user interface and functionality of a software application, such as a spreadsheet application. The software application may be a client software application executing on a client machine. The software application module may be optionally deployed in the same environment as the software application such that the software application module can be accessed from within the software application. The software application module may be optionally enabled or disabled within the environment (e.g., user interface) of the software application. The software application module may appear to be a part of the software application by, for example, providing user interface components or widgets (e.g., menus, toolbars, menu commands, toolbar commands, and so on) that can be enabled, disabled, added to, or removed from standard user interface components or widgets provided by the software application.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126 or NoSQL or non-relational data stores.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later redeem the accumulated value for products (e.g., goods or services) that are made available via the marketplace applications 120. While the marketplace and payment applications 120 and 122 are shown in FIG. 1 to both form part of the networked system 102, in alternative embodiments, the payment applications 122 may form part of a payment service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities. Additionally, although FIG. 1 depicts machines 130, 110, and 112 as being coupled to a single networked system 102, it will be readily apparent to one skilled in the art that machines 130, 110, and 112, as well as application 128 and clients 106 and 108, may be coupled to multiple networked systems. For example, the application 128 and clients 106 and 108 may be coupled to multiple payment applications 122, such as payment applications 122 associated with multiple payment processors (e.g., Visa, MasterCard, and American Express).

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace or payment functions that are supported by the relevant applications of the networked system 102.

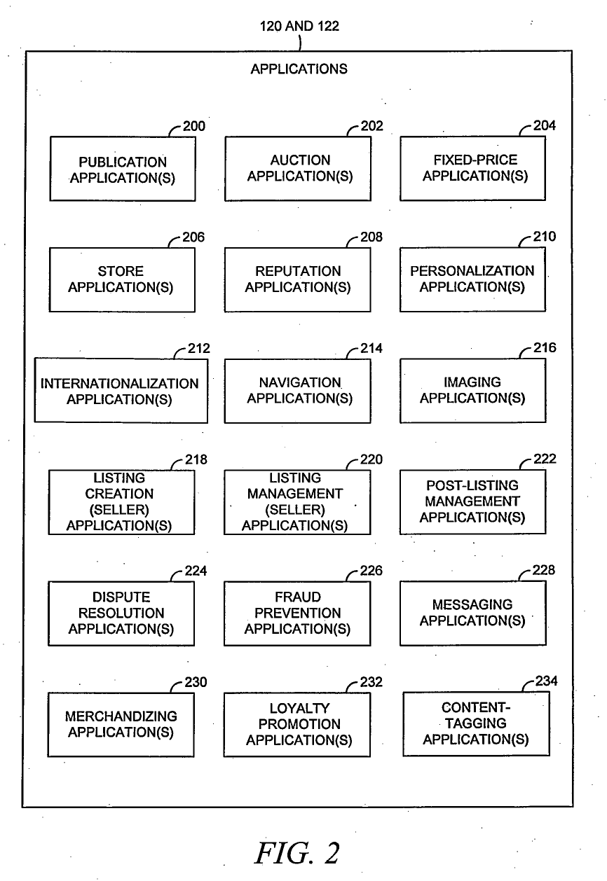

FIG. 2 is a block diagram illustrating multiple marketplace and payment applications applications 120 and 122 that, in various example embodiments, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database server(s) 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings available via the networked system 102 as visually informing and attractive as possible, the marketplace and payment applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. The listing creation application 218 and listing management applications 220 may allow sellers to manage listing in bulk (e.g., in a single operation, such as by an uploading of a file) and provide templates for sellers to manage category-specific, vendor-specific, or general-type-specific (e.g., catalog or ticket) listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via the guided procedures, the dispute may be escalated to a third-party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102. These messages may, for example, advise users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotions points for each transaction established and/or concluded with a particular seller, and may be offered a reward for which accumulated loyalty points can be redeemed.

Content-tagging applications 234, described in more detail below, manage associations between content items. For example, the content-tagging application 234 may enable a user of a network-based publication system to tag a portion of a news article referring to a product as being associated with a web page on the network-based publication system corresponding to the product.

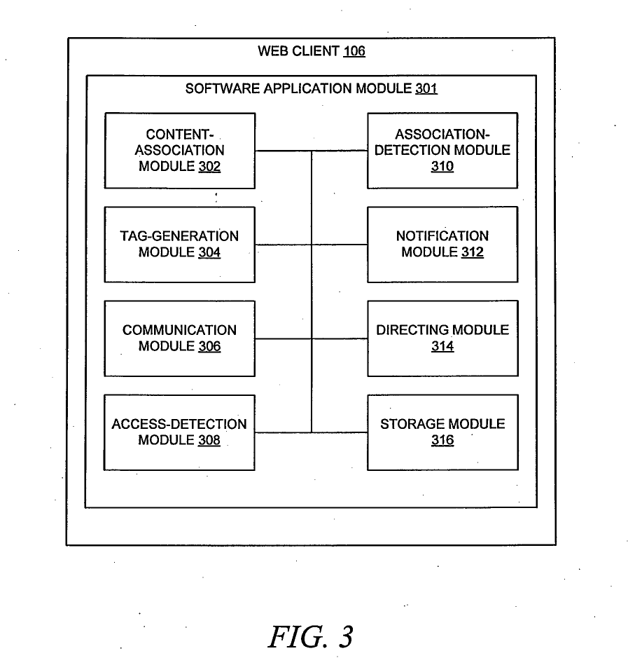

FIG. 3 is a block diagram illustrating example modules of a software application module 301 (e.g., a plug-in installed within an Internet browser application of a client machine) configured to enable a user of the software application module 301 to access or manage (e.g., create, modify, delete, or share) web tags or be notified of web tags managed by other users (e.g., via separate instances of the software application module 301 installed on separate clients or client machines). Although the software application module 301 is depicted as being included in the web client 106, one skilled in the art would understand that the software application module 301 may just as easily be included in another client, such as the programmatic client 108 or the third-party application 128. One skilled in the art would also understand that the software application module 301 could just as easily be a standalone software application.

The software application module 301 includes a content-association module 302 configured to enable a user of the software application module 301 to manage associations between content items. For example, the content-association module 302 may present a user interface to the user to enable the user to specify an association between a selected portion of a content item published on a news site or another network-based publication system (e.g., Amazon.com) with a selected content portion of a content item published at a network-based publication system.

The software application module 301 includes a tag-generation module 304 configured to generate web tags based on associations between content items specified by the user of the software application module 301.

The software application module 301 includes a communication module 306 configured to communicate with another application (e.g., the content-tagging application 234 of FIG. 2). For example, the communication module 306 may invoke an API of the content-tagging application 234 to request that the content-tagging application 234 store a web tag on a server. Or the communication module 306 may invoke an API of the content-tagging application 234 to request that the content-tagging application 234 share the web tag with other users.

The software application module 301 includes an access-detection module 308 configured to detect when a user accesses a content item (e.g., via a client application, such as a web browser).

The software application module 301 includes an association-detection module 310 that detects whether an association has been created between a first content item (e.g., a content item that the user is currently accessing) and a second content item (e.g., a web page corresponding to a product listed on a network-based publication system). For example, when a user accesses a content item at a particular URL (e.g., when the user accesses a web page via a web browser application, such as Microsoft Internet Explorer), the association-detection module 310 may identify that another user has shared a web tag defining an association between a portion of the web page and an additional web page (e.g., by calling an API of the content-tagging application 234 via the communication module 306).

The software application module 301 includes a notification module 312 that notifies a user of the detection of an association between a content item (e.g., a blog published by a blogger that the user is currently browsing with a web browser application) and an additional content item (e.g., a content item published by a network-based publication system, such as a web page listing a product for sale on the network-based publication system). For example, the notification module 312 may highlight a portion of the first content item (e.g., a word or an image) to indicate that that portion of the first content item has been associated with a second content item (e.g., that a web tag has been stored on a server and shared by an additional user).

The software application module 301 includes a directing module 314 configured to direct a user to a second content item associated with a first content item. For example, upon clicking the highlighted portion of the first content item, the directing module 314 may direct a web browser application of the user to access and display the second content item. Or the directing module 314 may present a user interface configured to enable the user to select from one of multiple possible locations based on the first content item having been associated with multiple additional content items.

The software application module 301 may include a storage module 316 to store data on a client machine (e.g., client machine 110). For example, the storage module 316 may store information about associations that a user has created between content items. Or the storage module 316 may store information about modifications that the user has made to such associations. Later, the information about the associations or modifications to the associations may be transmitted to a separate application (e.g., the content-tagging applications) for storage at a separate location (e.g., an external server) and for sharing with other users. The storage module 316 may also store configuration data, such as user preference data or communication session data, on a client machine.

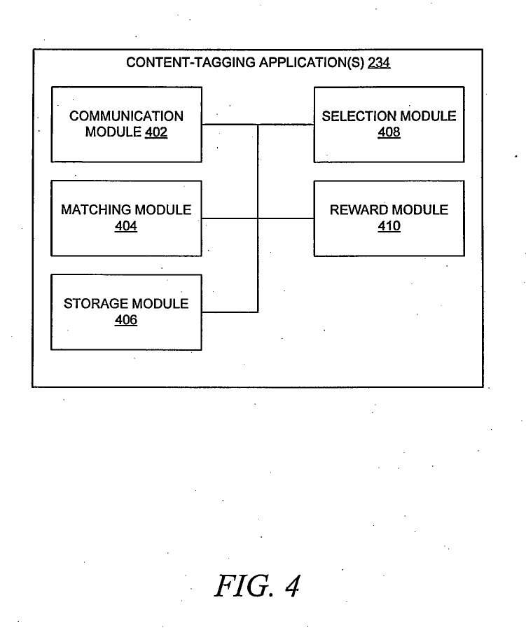

FIG. 4 is a block diagram illustrating example modules of the content-tagging application(s) 234 (of FIG. 2) configured to manage web tags (e.g., a server application executing on a server of a network-based publication system).

The content-tagging application(s) 234 may perform various operations related to managing web tags. For example, the content-tagging application(s) 234 may create, store, modify, or remove web tags. Or the content-tagging application(s) 234 may provide information about web tags (e.g., to enable the software application module 301 (FIG. 3) to detect an existence of a web tag and then notify a user of the existence of the web tag).

The content-tagging application(s) 234 include a communication module 402 configured to communicate with other applications (e.g., instances of the software application module 301). For example, the communication module 402 may receive a request (e.g., via an API) to store a web tag. Or the communication module 402 may receive a request to retrieve or provide information about a web tag. In response, the communication module 402 may transmit web tags or information about web tags to the other applications.

The content-tagging application(s) 234 may include a matching module 404 configured to identify candidate content items that may be related with a particular content item. For example, a client application (e.g., the software application module 301) may send information to the content-tagging application(s) 234 (e.g., via the communication module 402) that provides information (e.g., a URL, title, keywords, and so on) about a content item that a user is currently accessing (e.g., from a browser application). The matching module 404 may then identify one or more content items (e.g., a web page corresponding to a product listed on a network-based publication system) that may be related to the content item that the user is currently accessing. The matching module 404 may then communicate the one or more identified content items as candidate content items from which a user of the client application may select to associate with the content item that the user is currently accessing.

The content-tagging application(s) 234 may include a storage module 406 to store information about associations between content items on a server. For example, a client application (e.g., the software application module 301) may send a request to the content-tagging application(s) 234 (e.g., via the communication module 402) to store information pertaining to associations between content items identified by users. An example of such information may be a web tag generated by the client application. In response, the storage module 406 may store the information on a server such that the information can be accessed by multiple users via respective multiple instances of the client application.

The content-tagging application(s) 234 may include a selection module 408 configured to select information about associations between content items to communicate to a client application. For example, if a particular content item (e.g., a content item that a user is currently accessing) has been associated with multiple additional content items, when the content-tagging application(s) 234 receives (e.g., via the communication module 402) a request for information pertaining to the particular content item, the selection module 408 may select a subset of the multiple additional content items to communicate to the client application. The selection module 408 may base selections of associations to communicate to the client application on various factors, including a probability that a communication of each of the multiple additional content items will result in an operator of the network-based publication system receiving revenues from the user (e.g., via transaction fees or commissions from transactions conducted by the user on the network-based publication system). The selection module 408 may calculate a probability that a particular content item will generate revenues for the network-based publication system based on information about the item (e.g., a popularity of the item) or information about the user (e.g., a transaction history, browser history, and so on).

The content-tagging application(s) 234 may include a reward module 410 configured to cause rewards to be provided to users for identifying associations between content items. For example, the reward module 410 may cause a user to be provided with a cash reward, a coupon, or reward points for identifying an association between a popular blog posting published by a source that is external from the network-based publication system and a page corresponding to a product that is published by a source that is internal to the network-based publication system. The reward module 410 may credit the reward to an account of the user with respect to the network-based publication system. Alternatively, the reward module 410 may interface with an external system (e.g., a bank system or an advertising system) to cause the reward to be provided to the user.

Although various modules described above are depicted as being included in the content-tagging application(s) 234 or the software application module 301 respectively, one skilled in the art would recognize that the location of some modules is not fixed. For example, although the tag-generation module 304 (FIG. 3) is depicted as being included in the software application module 301, the tag-generation module 304 would work equally well if it was included in the content-tagging application(s) 234.

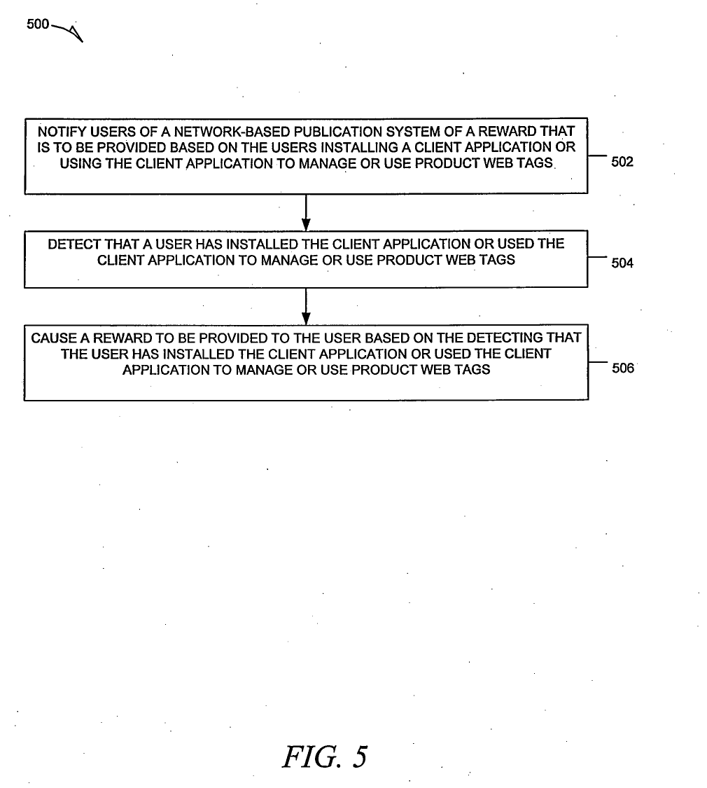

FIG. 5 is a flowchart illustrating an example method 500 of incentivizing users of a network-based publication system to install a client application (e.g., the software application module 301 of FIG. 3) or use the client application to manage product web tags. At operation 502, the messaging applications 228 (of FIG. 2) notify users of a network-based publication system of a reward that is to be provided based on the users installing the client application or using the client application to manage or use product web tags. Examples of rewards that may be offered include cash, coupons, or reward points (e.g., eBay Bucks).

At operation 504, the content-tagging applications 234 detect (e.g., via the communication module 402) that a user of the network-based publication system has installed or used the client application. For example, the communication module 402 may receive a notification from the software application module 301 that the software application module 301 has been installed on the client machine 110. Or the communication module 402 may receive a request from the software application module 301 to store and share a product web tag that is generated based on input from the user. Or the communication module 402 may receive a request from the software application module 301 to provide information about associations between a content item that a user is currently accessing (e.g., a new article published by a news site) and one or more additional content items corresponding to products listed (e.g., as being for sale) on the network-based publication system.

At operation 506, the reward module 410 causes a reward to be provided to the user based on the detection that the user installed or used the client application. For example, the reward module 410 may directly credit an account of the user with cash or reward points. Or the reward module 410 may interface with an external system (e.g., a banking system or an advertising system) to cause the reward to be provided to the user.

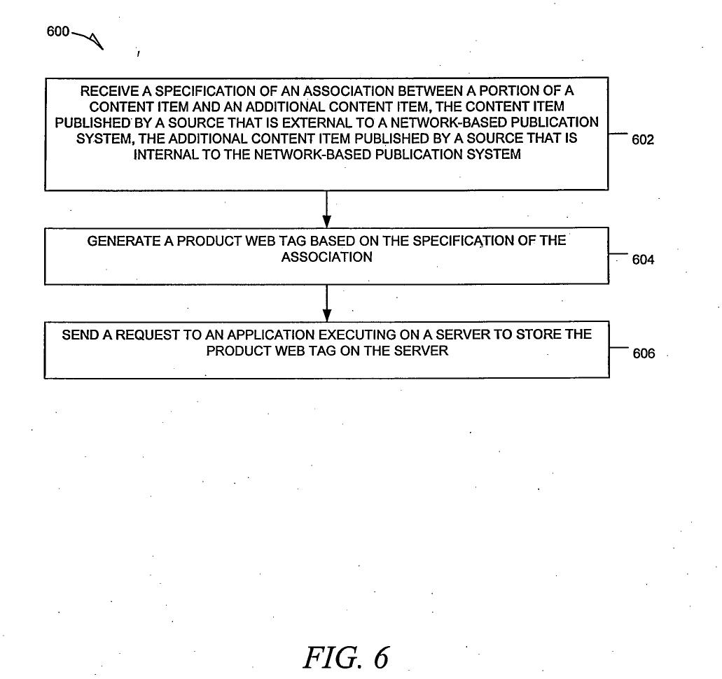

FIG. 6 is a flowchart illustrating an example method 600 of enabling users of a network-based publication system to share product web tags with one another. At operation 602, the content-association module 302 (FIG. 3) receives a specification of an association between a portion of a content item and an additional content item, the content item published by a source that is external to the network-based publication system, the additional content item published by a source that is internal to the network-based publication system. For example, the content-association module 302 receives a specification of an association between an image or a keyword of an article published by a news source and a web page corresponding to a product listed on the network-based publication system.

At operation 604, the tag-generation module 304 generates a product web tag based on the specification of the association. At operation 606, the communication module 306 sends a request to another application (e.g., the content-tagging application 234) to store that product web tag on a server such that it may be accessed by other users.

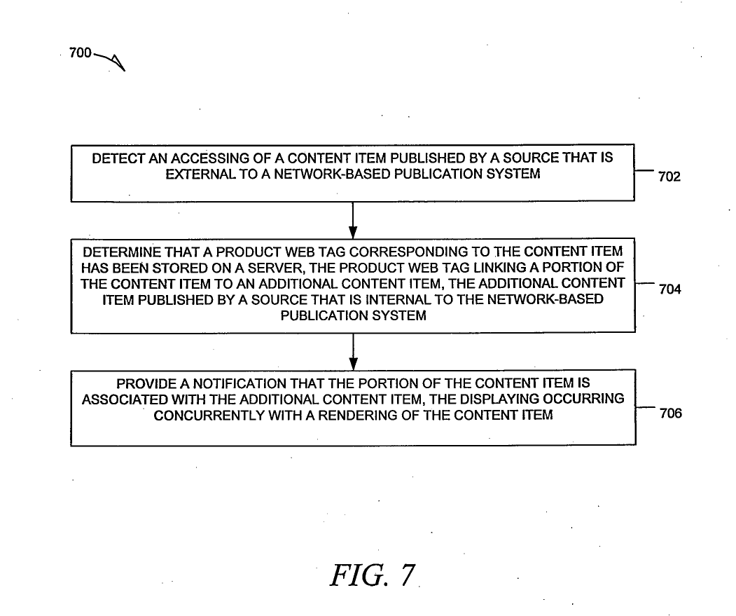

FIG. 7 is a flowchart illustrating an example method 700 of sending a notification of an association between a content item that a user is currently accessing and an additional content item (e.g., a web page corresponding to a product listed on a network-based publication system). At operation 702, the access-detection module 308 (FIG. 3) detects that a user has accessed a content item (e.g., that the user is browsing a web page using a web browser).

At operation 704, the association-detection module 310 detects an association between the content item that the user is currently accessing and an additional content item. For example, the association-detection module 310 requests (e.g., via the communication module 306) information pertaining to associations between the content item that the user is currently accessing and additional content items. As part of the request, the association-detection module may include the URL, title, or keywords of the content item that the user is currently accessing. In response to the request, the association-detection module 310 may receive information (e.g., via the communication module 402) about one or more product web tags that have been created by one or more additional users and shared on a server so that multiple users can access.

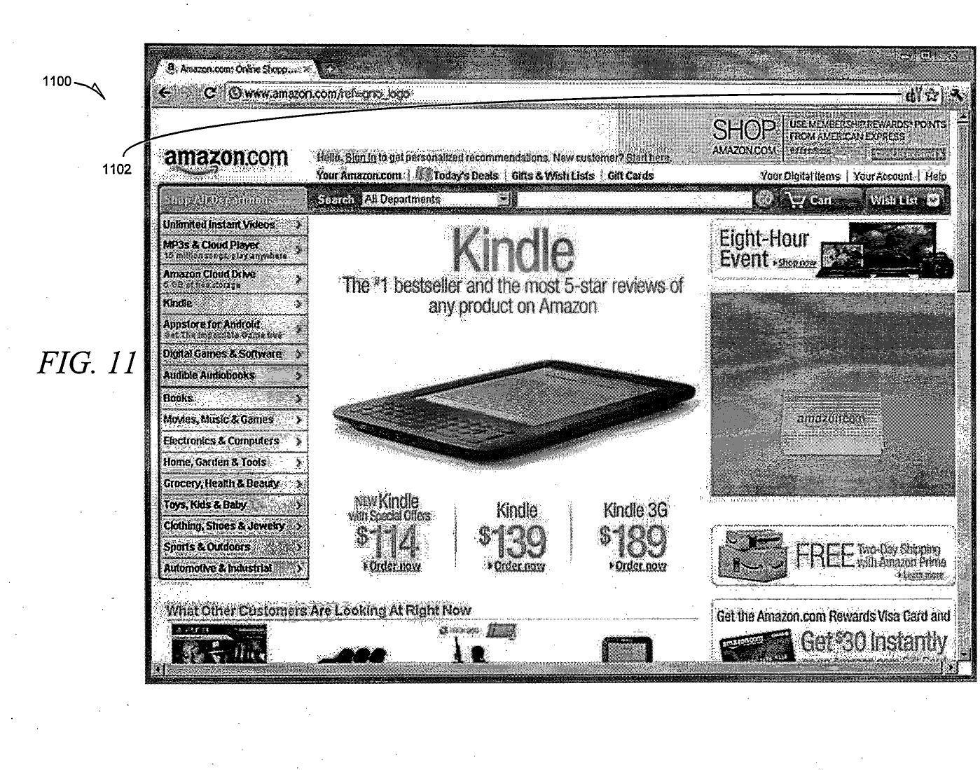

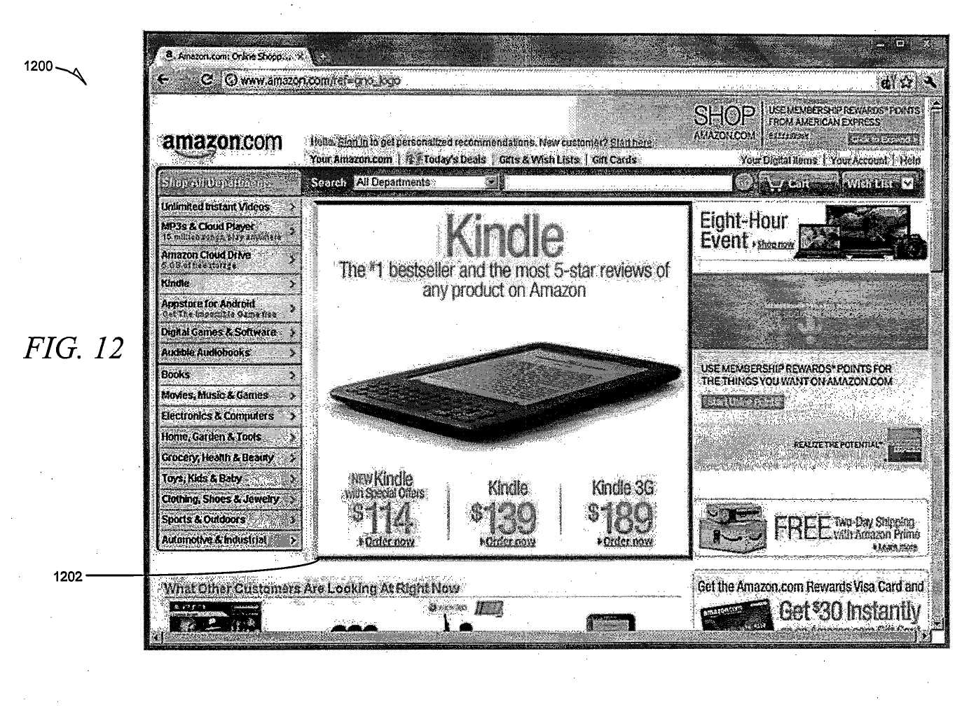

At operation 706, the notification module 312 provides a notification of one or more associations between the content item that the user is currently viewing and one or more additional content items. For example, the notification module 312 displays an indicator in the user's web browser indicating that an association exists (e.g., see FIG. 11). Or the notification module 312 highlights a portion of the content item for which an association has been created and shared by an additional user (e.g., see FIG. 12).

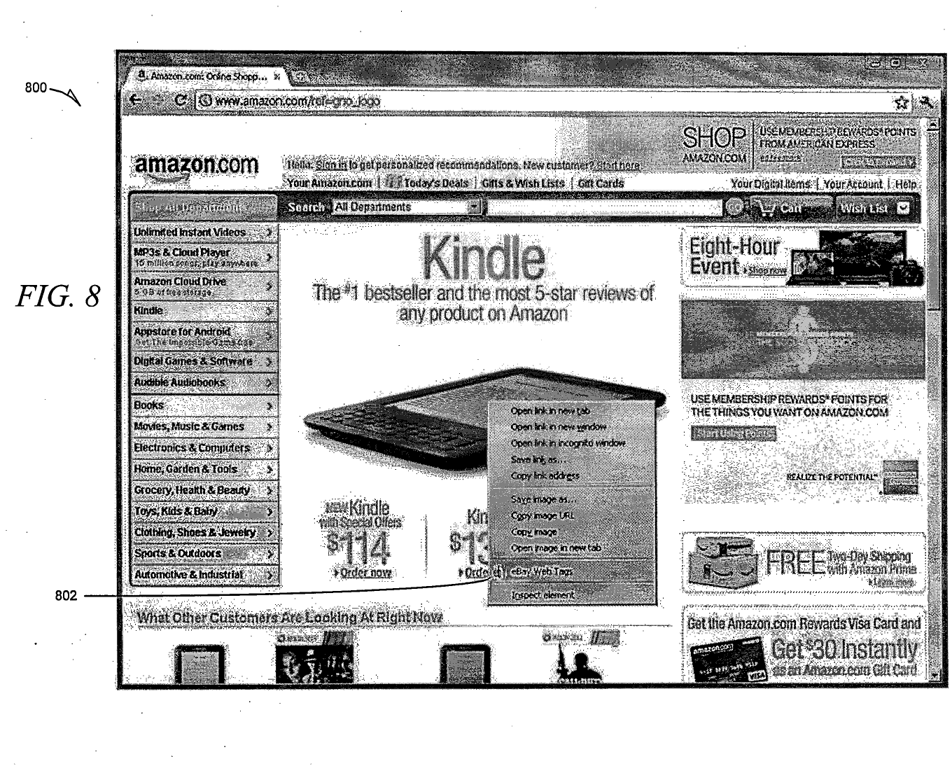

FIG. 8 is a screenshot of an example user interface 800 for accessing a user interface for managing web tags. The example user interface 800 may be presented by the content-association module 302 (FIG. 3). The example user interface 800 includes a menu item 802 (e.g., “eBay Web Tags”) that appears on a context menu of a web browser application. A user may access the context menu by right-clicking on a content item (or a portion of a content item) that is currently being accessed by the user and displayed in the web browser application. The user may cause a user interface for managing web tags for the content item to be displayed by selecting (or left-clicking on) the menu item 802.

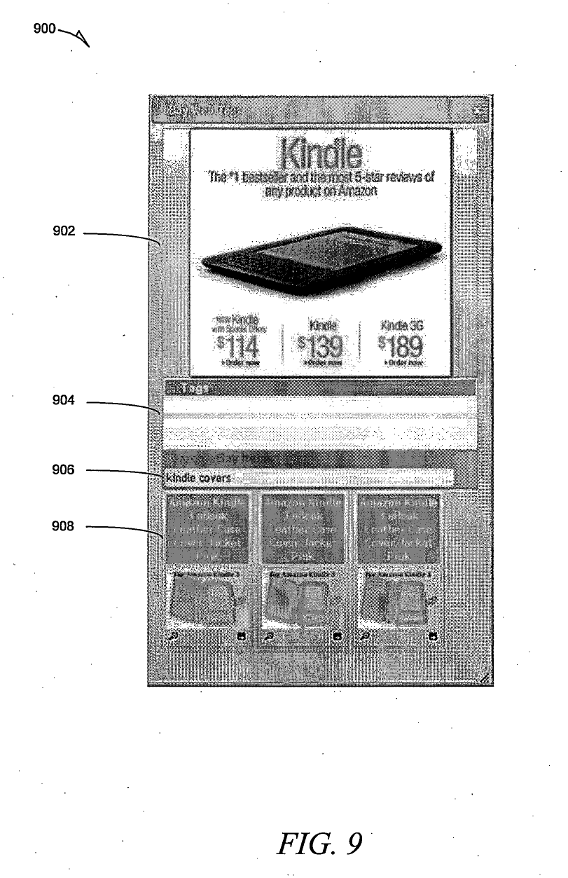

FIG. 9 is a screenshot of an additional example user interface 900 for managing product web tags. The example user interface 900 may be presented by the content-association module 302 (FIG. 3). The example user interface 900 includes a content item region 902 for displaying an image of a selected content item (or portion of the content item) (e.g., an advertisement for a Kindle) for which the user may create a product web tag. The user interface 900 includes a web tag region 904 (currently empty) for displaying thumbnail images and titles of content items (e.g., web pages) corresponding to products listed on the network-based publication system that have been associated with the content item displayed in the content item region 902. The user interface 900 includes a search box 906 for searching for items on the network-based publication system by keywords. The user interface 900 includes a search results box 908 for displaying search result items, including thumbnail images and titles of content items corresponding to products listed on the network-based publication system that match the keywords entered in search box 906. Upon detecting a dragging and dropping of a search result item from the search results box 908 to the web tag region 904, the content-association module 302 may create a web tag that associates the content item corresponding to the search result item to the selected content item displayed in the content item region 902.

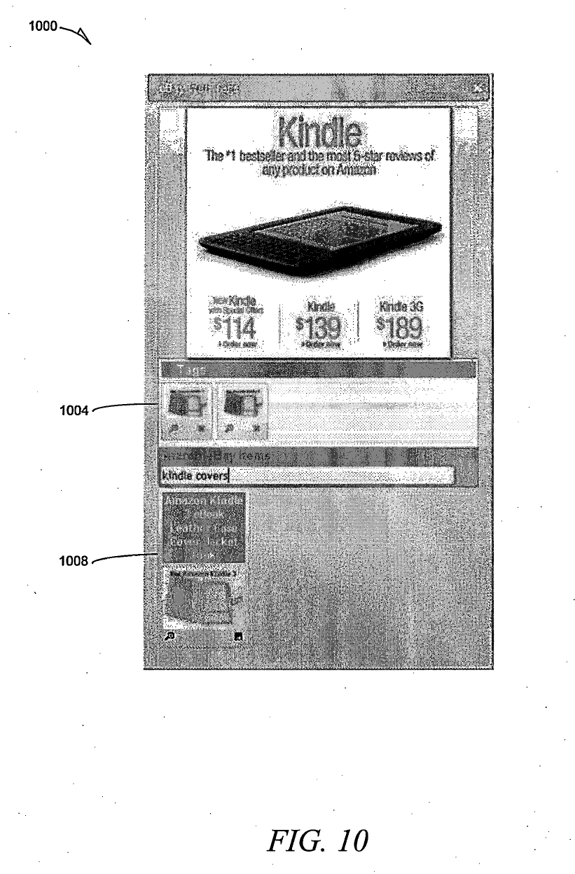

FIG. 10 is a screenshot of an example user interface 1000 for managing product web tags. The example user interface 1000 may be presented by the content-association module 302 (FIG. 3). The example user interface 1000 is similar to the example user interface 900. However, unlike example user interface 900, example user interface 1000 includes two product web tag items in the product web tags region 1004. In other words, example user interface 900 shows the result of a user dragging and dropping items from the search results box 1008 into the product web tags region 1004.

FIG. 11 is a screenshot of an example user interface 1100 for notifying a user of the existence of a product web tag for a content item that the user is currently accessing. The example user interface 1100 may be presented by the notification module 312 (FIG. 3). The example user interface 1100 includes an icon 1102 next to the address (URL) box of the client application (e.g., a web browser) that the user is using to access the content item. The icon indicates that a product web tag exists (e.g., has been created and shared by another user) for the content item.

FIG. 12 is a screenshot of an example user interface 1200 for highlighting a portion of a content item for which a product web tag has been created. The example user interface 1200 may be presented by the notification module 312 (e.g., in response to a user clicking on the icon 1102). The highlighting may include displaying a multi-colored box with raised edges around the portion of the content item.

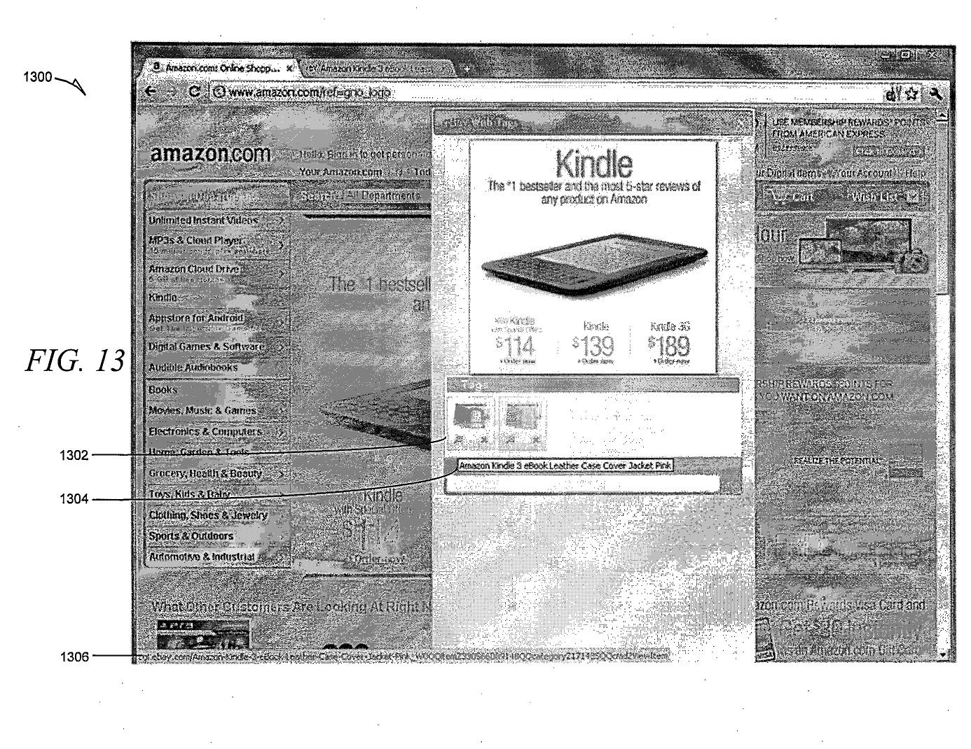

FIG. 13 is a screenshot of an example user interface 1300 for viewing information about product web tags that have been created for a content item. The example user interface 1300 may be displayed by the notification module 312 (FIG. 3). The example user interface may include a product web tags region 1302 for displaying thumbnail images of content items that have been associated with a content item that the user is currently viewing (e.g., a product web page for a Kindle on Amazon.com). The example user interface 1300 may include title hint text 1304 that appears when the user places the mouse cursor over one of the thumbnail images displayed in the product web tags region 1302. The example user interface 1300 may also include information about the location (e.g., URL) of a content item that has been associated with the content item that the user is currently viewing.

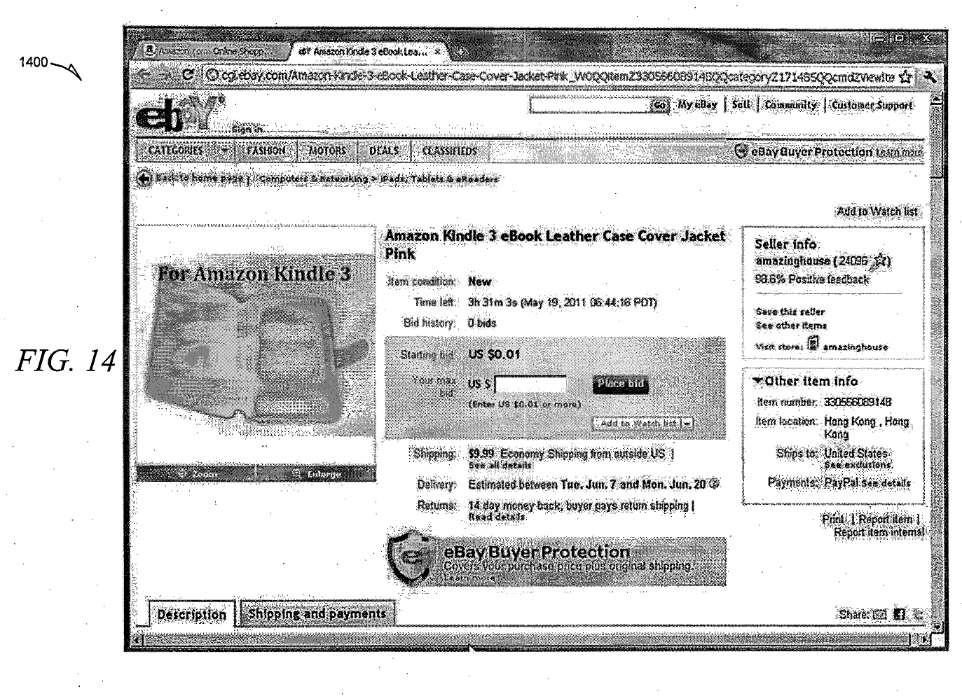

FIG. 14 is a screenshot of an example user interface 1400 of a web page to which a user is directed upon clicking on a content item or a portion of a content item for which a product web tag has been created. The directing module 314 (FIG. 3) may direct the client application (e.g., the web browser), in which the user was originally accessing a content item for which a product web tag was defined, to access an additional content item that has been associated with the originally-accessed content item based on the product web tag. For example, upon detecting that a user has clicked on the portion of the originally-accessed content item, the directing module may direct the client application to display a product page on the network-based publication system that has been associated with the originally-accessed item. Here, the product page represents a web page of the network-based publication system on which the user may place a bid for a Kindle cover.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

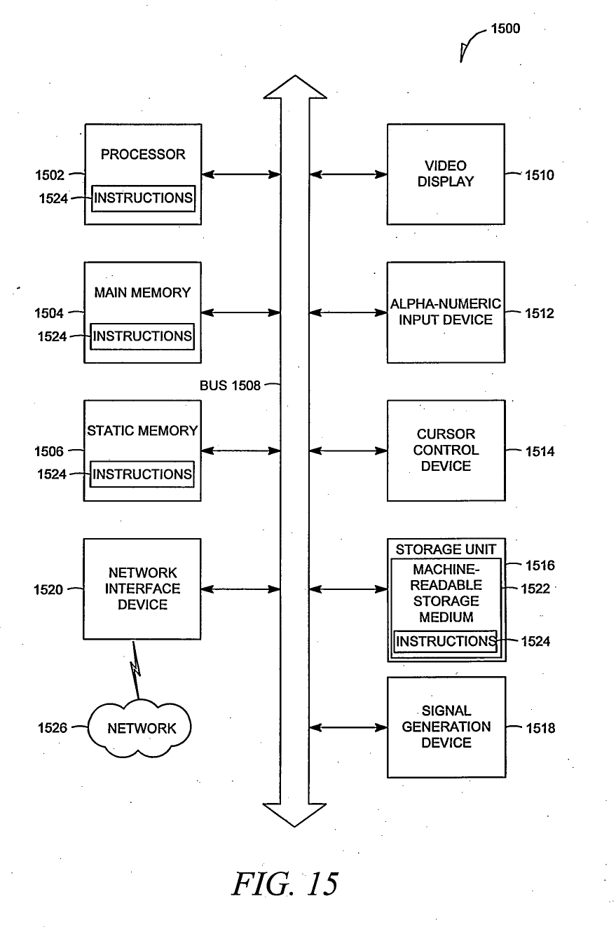

FIG. 15 is a block diagram of machine in the example form of a computer system 1500 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a user interface (UI) navigation (or cursor control) device 1514 (e.g., a mouse), a storage (e.g., disk drive) unit 1516, a signal generation device 1518 (e.g., a speaker) and a network interface device 1520.

The disk drive unit 1516 includes a machine-readable medium 1522 on which is stored one or more sets of data structures and instructions (e.g., software) embodying or utilized by any one or more of the methodologies or functions described herein. The instructions 1524 may also reside, completely or at least partially, within the main memory 1504 and/or within the processor 1502 during execution thereof by the computer system 1500, the main memory 1504 and the processor 1502 also constituting machine-readable media. The instructions 1524 may also reside, completely or at least partially, within the static memory 1506.

While the machine-readable medium 1522 is shown in an example embodiment to be a single medium, the term “machine-readable medium” may include a single medium or multiple media (e.g., a centralized or distributed database, and/or associated caches and servers) that store the one or more instructions 1524 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1526 may be the network 104.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
sharing a product web tag, the sharing of the product web tag including handling an invocation of an application program interface at an application executing on a server to store the product web tag on the server, the product web tag defining an association between a portion of a content item and an additional content item, the content item published by a source that is external to a network-based publication system, the additional content item published by a source that is internal to the network-based publication system; and
causing a reward to be provided based on the sharing of the product web tag.

2. The method of claim 1, wherein the portion of the content item is one of an image, a portion of the image, a video, a portion of the video, and text.

3. The method of claim 1, wherein the additional content item is a web page that includes information about a product that is listed for sale on the network-based publication system.

4. A method comprising:
receiving a specification of an association between a portion of a content item and an additional content item, the content item published by a source that is external to a network-based publication system, the additional content item published by a source that is internal to the network-based publication system;
generating a product web tag based on the specification of the association, the product web tag linking the portion of the content item to the additional content item; and
sending a request to an application executing on a server to share the product web tag on the server.

5. The method of claim 4, wherein the receiving includes detecting a dragging and dropping of a visual representation of the additional content item on a region of a user interface.

6. The method of claim 5, further comprising:
receiving a query via the user interface;
presenting in the user interface a plurality of visual representations of candidate content items that match the query; and
receiving a selection of one of the plurality of candidate content items as the additional content item.

7. A method comprising:
detecting an accessing of a content item published by a source that is external to a network-based publication system;
detecting that a product web tag corresponding to the content item has been shared on a server, the product web tag defining an association between a portion of the content item and an additional content item, the additional content item published by a source that is internal to the network-based publication system; and
displaying a notification that the portion of the content item is associated with the additional content item, the displaying occurring concurrently with a rendering of the content item.

8. The method of claim 7, further comprising:
retrieving information about the product web tag via an application program interface; and
displaying a visual representation of the information.

9. The method of claim 8, wherein the displaying of the visual representation of the information includes displaying a thumbnail image of the additional content item.

10. The method of claim 8, further comprising causing the additional content item to be displayed in response to a detecting of an interaction with the visual representation.

11. A system comprising:
at least one processor; and
a content-tagging application, implemented by the at least one processor, configured to:
share a product web tag, the sharing of the product web tag including handling an invocation of an application program interface at an application executing on a server to store the product web tag on the server, the product web tag defining an association between a portion of a content item and an additional content item, the content item published by a source that is external from a network-based publication system, the additional content item published by a source that is internal to the network-based publication system; and
cause a reward to be provided based on the sharing of the product web tag.

12. The system of claim 11, wherein the portion of the content item is one of an image, a portion of the image, a video, a portion of the video, and text.

13. The system of claim 11, wherein the additional content item is a web page that includes information about a product that is listed for sale on the network-based publication system.

14. A system comprising:
at least one processor;
a content-association module, implemented by the at least one processor, configured to receive a specification of an association between a portion of a content item and an additional content item, the content item published by a source that is external to a network-based publication system, the additional content item published by a source that is internal to the network-based publication system;
a tag-generation module, implemented by the at least one processor, configured to generate a product web tag based on the specification of the association, the product web tag linking the portion of the content item to the additional content item; and
a communication module, implemented by the at least one processor, configured to send a request to an application executing on a server to share the product web tag on the server.

15. The system of claim 14, wherein the receiving of the specification of the association between the portion of the content item and the additional content item includes detecting a dragging and dropping of a visual representation of the additional content item on a product web tags region of a user interface.

16. The system of claim 15, wherein the content-association module is further configured to:
receive a query via the user interface;
present in the user interface a plurality of visual representations of candidate content items that match the query; and
receive a selection of one of the plurality of candidate content items as the additional content item.

17. A system comprising:
at least one processor;
an access-detection module, implemented by the at least one processor, configured to detect an accessing of a content item published by a source that is external to a network-based publication system;
an association-detection module, implemented by the at least one processor, configured to detect that a product web tag corresponding to the content item has been shared on a server, the product web tag defining an association between a portion of the content item and an additional content item, the additional content item published by a source that is internal to the network-based publication system; and
a notification module, implemented by the at least one processor, configured to display a notification that the portion of the content item is associated with the additional content item, the displaying occurring concurrently with a rendering of the content item.

18. The system of claim 17, further comprising a communication module configured to retrieve information about the product web tag via an application program interface and wherein the notification module is further configured to display a visual representation of the information.

19. The system of claim 18, wherein the displaying of the visual representation of the information includes displaying a thumbnail image of the additional content item.

20. The system of claim 18, further comprising a direction module to cause the additional content item to be displayed in response to a detecting of an interaction with the visual representation.

21. A non-transitory machine readable medium embodying a set of instructions that, when executed by a processor, cause the processor to perform operations comprising:
sharing a product web tag, the sharing of the product web tag including handling an invocation of an application program interface at an application executing on a server to store the product web tag on the server, the product web tag defining an association between a portion of a content item and an additional content item, the content item published by a source that is external to a network-based publication system, the additional content item published by a source that is internal to the network-based publication system; and
causing a reward to be provided based on the sharing of the product web tag.

22. The non-transitory machine readable medium of claim 21, wherein the portion of the content item is one of an image, a portion of the image, a video, a portion of the video, and text.

23. The non-transitory machine readable medium of claim 21, wherein the additional content item is a web page that includes information about a product that is listed for sale on the network-based publication system.

24. A non-transitory machine-readable medium embodying a set of instructions that, when executed by a processor, cause the processor to perform operations comprising:
receiving a specification of an association between a portion of a content item and an additional content item, the content item published by a source that is external to a network-based publication system, the additional content item published by a source that is internal to the network-based publication system;
generating a product web tag based on the specification of the association, the product web tag linking the portion of the content item to the additional content item; and
sending a request to an application executing on a server to share the product web tag on the server.

25. The non-transitory machine-readable medium of claim 24, wherein the receiving includes detecting a dragging and dropping of a visual representation of the additional content item on a region of a user interface.

26. The non-transitory machine-readable medium of claim 25, further comprising:
receiving a query via the user interface;
presenting in the user interface a plurality of visual representations of candidate content items that match the query; and
receiving a selection of one of the plurality of candidate content items as the additional content item.

27. A non-transitory machine-readable medium embodying a set of instructions that, when executed by a processor, cause the processor to perform operations comprising:
detecting an accessing of a content item published by a source that is external to a network-based publication system;
detecting that a product web tag corresponding to the content item has been shared on a server, the product web tag defining an association between a portion of the content item and an additional content item, the additional content item published by a source that is internal to the network-based publication system; and
displaying a notification that the portion of the content item is associated with the additional content item, the displaying occurring concurrently with a rendering of the content item.

28. The non-transitory machine-readable medium of claim 27, further comprising:
retrieving information about the product web tag via the application program interface; and
displaying a visual representation of the information.

29. The non-transitory machine-readable medium of claim 28, wherein the displaying of the visual representation of the information includes displaying a thumbnail image of the additional content item.

30. The non-transitory machine-readable medium of claim 28, further comprising causing the additional content item to be displayed in response to a detecting of an interaction with the visual representation.
